(19) United States
(12) Patent Application Publication
(10) Pub. No.: US 2009/0119860 A1
(43) Pub. Date: May 14, 2009

(54) Riveted joint based on plastic

(76) Inventor: Klaus Amsel, Schmitten (DE)

Correspondence Address: FISH & RICHARDSON PC, P.O. BOX 1022, MINNEAPOLIS, MN, 55440-1022, US

(21) Appl. No.: 12/293,065

(22) PCT Filed: Jan. 13, 2007
(86) PCT No.: PCT/EP07/00282

§ 371 Date: Sep. 15, 2008

(30) Foreign Application Priority Data
Mar. 16, 2006 (DE) 10 2006 012 043.4

(51) Int. Cl. A46B 7/08; F16B 9/00; F16D 1/00

(52) U.S. Cl. 15/167.1; 403/249; 403/408.1

(57) ABSTRACT

A riveted joint and a method for forming a riveted joint based on plastic. The riveted joint having a thermoplastically shapeable riveted bolt that can be inserted into a rivet through-hole provided for this purpose in a holding part. To create a rotationally movable riveted joint, a sliding layer, such as a lubricant, is provided on the side of the holding part facing away from the rivet part.

### CROSS-REFERENCE TO RELATED APPLICATIONS

This application is the national stage of International Application No. PCT/EP2007/000282, filed Jan. 13, 2007, which claims priority to German Application No. DE102006012043.4, filed Mar. 16, 2006.

### TECHNICAL FIELD

The present invention relates to a riveted joint.

### BACKGROUND

By means of a riveted joint, two components can be joined together in a form-fitting manner by a plastically shapeable connecting element, namely the rivet, which is usually cylindrical. One application of riveted joints is for non-releasable joining of metal parts, such as steel beams, aircraft parts or ship parts.

One of the components to be joined by means of a riveted joint has a rivet shaft, usually cylindrical, or a rivet head, which is passed through a rivet through-hole in the other component. The riveted bolt is shaped in width after passing the riveted bolt through the hole, so that the two components are joined together inseparably in a form-fitting manner.

In the case of riveted joints based on plastic, i.e., joints in which at least the plastically shapeable riveted bolt is made of plastic, the shaping of the riveted bolt, which is often used to form the riveted joint, is achieved under the influence of heat.

The riveted bolt, which is typically made of a thermoplastic material, for example, is heated to a predetermined melting point, e.g., by means of a hot gas nozzle, and then is shaped to form a rivet head by means of a cold ram.

If the same type of plastic is used for the two components that are to be joined together by means of a riveted joint, an integrally bonded joint is formed between the heated rivet head and the holding part. Even when using different plastics that are plastically shapeable in the same temperature range, an integrally bonded joint of the parts comes about due to the melting of the rivet in at least some areas following its thermoplastic shaping, thereby decreasing or preventing relative rotatability or mobility of the joined parts.

### SUMMARY

In one aspect, an embodiment provides a riveted joint based on plastic, in which the components that are joined together are movable with respect to one another in the plane perpendicular to the rivet.

In some implementations, a riveted joint based on plastic has two components: a rivet part and a holding part provided for it. A riveted bolt, preferably cylindrical in design, is formed on the rivet part, extending essentially perpendicular to the plane of the rivet part. The holding part has a rivet through-hole, which is provided for the riveted bolt and has a larger bore accordingly. A sliding layer is provided on the side of the holding part facing away from the rivet part and should counteract the formation of a physically bonded joint.

Following thermoplastic shaping of the rivet which is passed through the through-hole, direct contact between the rivet head and the holding part is prevented or reduced, so that the holding part, which is preferably made of the same plastic as the rivet, is less likely to form an integrally bonded joint with the rivet head in the area of its surface facing the rivet head.

The sliding layer thus prevents or impedes the formation of an integrally bonded joint between the holding part and the rivet part, so that the connection joining the two parts is formed essentially only on the basis of the form-fitting joining of the rivet head to the holding part. Depending on the design of the riveted bolt and the rivet through-hole, the two components, i.e., the rivet part and the holding part, are movable relative to one another in the plane perpendicular to the rivet shaft, preferably being rotatable about the axis formed by the rivet.

According to a first embodiment, the at least one riveted bolt and/or the rivet part is/are made of a thermoplastic material. The sliding layer arranged on the holding part is essentially heat-resistant, at least in the temperature range of elastic shapeability of the riveted bolt. Consequently, the sliding layer then retains its function even when it comes in direct contact with the heated riveted bolt or rivet head.

According to another embodiment, the sliding layer covers at least one edge area adjacent to the rivet through-hole in the form of a ring. The radial extent of the sliding layer here corresponds essentially to the radial extent of the undercut of the rivet head that can be shaped from the riveted bolt. This increases the likelihood that the entire area of the undercut formed by the rivet head does not come into a direct contact position with the holding part when the riveted joint is assembled. The sliding layer here forms a dividing layer between the undercut of the rivet head and the surface of the holding part facing the rivet head.

According to another embodiment, the holding part and the rivet part are movable relative to one another when the riveted joint is formed. Depending on the embodiment of the riveted bolt and the rivet through-hole, which may be formed as an essentially circular hole or in the form of an elongated slot, for example, the components that are joined together by a riveted joint are displaceable relative to one another, for example, and in some implementations, are designed to be rotatable relative to one another. The relative rotation of the rivet part and the holding part here is preferably about the axis formed by the riveted bolt.

In addition, the rivet through-opening is designed as an essentially round borehole or as an elongated slot and/or as an elongated coulisse, e.g., in the manner of an elongated slot. Especially versatile use of certain embodiments of the riveted joint, e.g., as a rotationally movable joint or optionally a one-dimensional or two-dimensional guide can thus be implemented. The mutual displacement and/or rotation of the interconnected components, as universally as possible, can be made available, depending on the geometric design of the rivet through-hole.

According to another embodiment, a film made of wax, in particular peppermint wax, is provided for the sliding layer. The surface of the holding part facing the rivet part may be coated very easily with such a wax, preferably with a thin film of wax. Peppermint wax has the thermal stability adequate for thermoplastic shaping of certain embodiments of the rivet.

Alternatively, instead of a wax, a corresponding oil which forms a lubricant film may also be used.

According to another independent aspect, some embodiments provide a method for forming a riveted joint based on plastic and having at least one rivet part and a corresponding holding part. A riveted bolt is integrally molded on the rivet part, passing through a rivet through-hole in the holding part to form the riveted joint. The method for forming the riveted joint is characterized in that before thermoplastic shaping of the riveted bolt in a rivet head, a sliding layer is provided on the side of the holding part facing the rivet head.

The sliding layer, preferably comprising a thin film of lubricant, may be applied to the holding part, e.g., in the form of a film of wax, at the time of manufacturing of the holding part. Alternatively, it is also conceivable for the sliding layer to be applied only immediately before a thermoplastic shaping process for the riveted bolt. The latter is advantageous, for example, when using an oil film that can be sprayed on as the sliding layer, e.g., after passing the riveted bolt through the rivet through-hole.

An embodiment of the riveted joint based on plastic is suitable in particular for use in replaceable attachable brushes for electric toothbrushes. It is used here for implementation of a rotationally movable connection of a rotationally movable toothbrush head with a toothbrush neck. In this way, a permanent heavy-duty joint which is rotationally movable in particular is established between a brush neck and a brush head that can be rotated by an electric motor.

The present invention is not limited to use in the field of toothbrushes, but instead may be used universally for any type of plastic riveted joints.

Additional goals, features and advantageous possible applications are derived from the following description of exemplary embodiments on the basis of the drawings. All the features described here and/or illustrated in the drawings constitute the subject matter of the present description in their logical combination, even independently of the patent claims.

### BRIEF DESCRIPTION OF THE DRAWINGS

FIG. 1 shows a perspective view of the two components forming the riveted joint,

FIG. 2 shows a cross section through the two components joined together,

FIG. 3 shows a cross section according to FIG. 2 after thermoplastic shaping of the riveted bolt,

FIG. 4 shows a perspective diagram of a rotatable and displaceable riveted joint, and

FIG. 5 shows a cross section through the two components according to FIG. 4.

### DETAILED DESCRIPTION

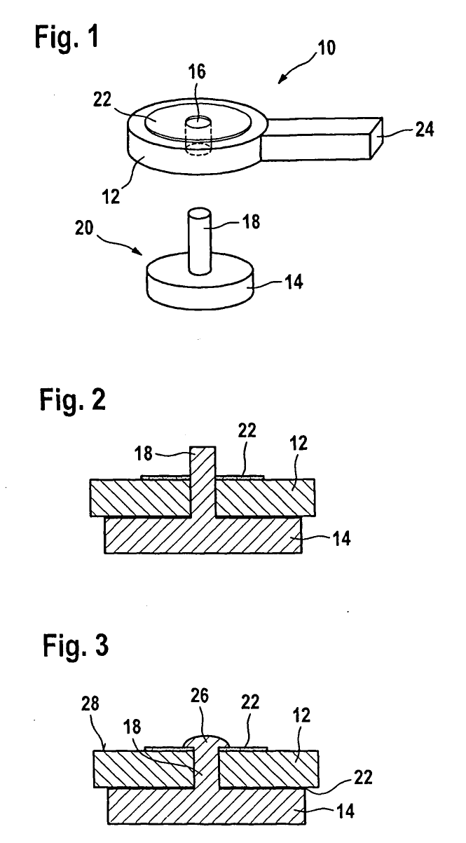

FIG. 1 shows a perspective diagram of the two components that are to be joined, namely the holding part 10 and the rivet part 20, which form a rotationally movable riveted joint, as shown in FIG. 2. The rivet part 20 has a base 14 on which a riveted bolt or rivet shaft 18 extends essentially vertically upward.

According to this embodiment of the riveted bolt 18, the holding ring 12 of the holding part 10 has a rivet through-hole 16 into which the riveted bolt 18 is to be inserted to form the riveted joint. In addition, a handle or shaft 24 is integrally molded on the holding ring 12, representing a toothbrush neck, for example. The base 14 may be connected to other parts, such as a toothbrush head, or parts having other functions, e.g., toothbrush bristles, may be attached to the base 14 and/or to the rivet part 20.

A sliding layer 22 is provided on the top side of the ring-shaped holding part 10 in the area around the rivet through-opening 16. This sliding layer covers at least a radial area around the rivet through-opening 16, an area which corresponds at least to the radial extent of the undercut formed by the rivet head 26. Depending on the manufacturing process, the sliding layer 22 may be designed as a film of heat-resistant wax or oil, for example. It is conceivable here in particular that the sliding layer 22 also covers the entire top side of the ring-shaped holding part 10.

FIG. 2 shows a cross-sectional diagram of the holding part 10 and the rivet part 20 joined together, whereby the base 14 of the rivet part 20 comes into contact essentially completely with the bottom side of the holding ring 12. The riveted bolt 18 passes through the rivet through-hole 16 of the holding ring 12 here. In this intermediate stage, which is illustrated in FIG. 2, the two components 12, 14 are not yet joined together in a form-fitting manner.

A form-fitting connection is achieved between the two components 12, 14 by thermoplastic shaping of the rivet 18 to form a rivet head 26, as shown in FIG. 3, the rivet head being wider radially in comparison with the rivet shaft 18. The heat-resistant sliding layer 22, which is in contact with the top side 28 of the holding ring 12, prevents or reduces the formation of an integrally bonded joint between the bottom side of the rivet head 26 and the holding ring 12. A rotationally movable connection between the rivet part 20 and the holding part 10 is created, allowing relative rotation or pivoting about an axis parallel to the rivet shaft 18.

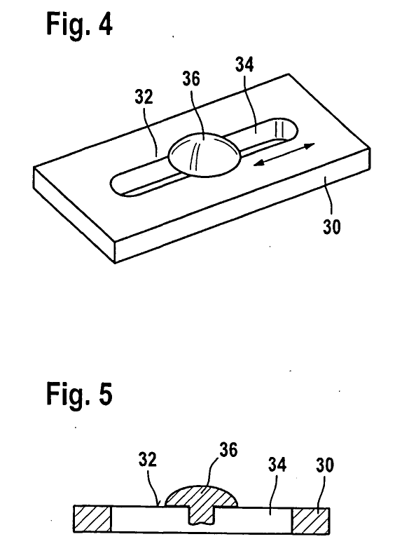

Finally, FIGS. 4 and 5 show another embodiment with an elongated rivet through-hole 34 designed in the manner of a coulisse on the holding part 30. The joining mechanism is essentially identical to that in FIGS. 1 through 3 described previously. Here again, a sliding layer is provided at least in an edge area around the coulisse 34 on the top side of the holding part 30, so that displaceability of the two components joined together is facilitated. The base component having the rivet or the rivet head is displaceable through the riveted joint in at least one direction relative to the holding part 30.

1-7. (canceled)

8. A method of attaching two plastic members with, a thermoplastic rivet such that the two-plastic members remain moveable relative to one another, the method comprising:
inserting a thermoplastic pin of a first member into an opening defined by a second plastic member;
applying a bond-inhibiting material to the second plastic member near the opening; and
with the pin inserted and the bond-inhibiting material applied, applying pressure to a distal end of the pin under conditions that cause the distal end of the pin to deform and form a head that retains the second member to the first member, wherein while the bond-inhibiting material inhibits bonding of the head, of the pin to fee second plastic member.

9. The method of claim 8, wherein applying the bond-inhibiting material comprises applying material that comprises wax.

10. The method of claim 8, wherein applying the bond-inhibiting material comprises spraying a film of peppermint wax on the second plastic member.

11. The method of claim 8, wherein applying the bond-Inhibiting material comprises applying a material that is heat resistant to a temperature at which the distal end of the thermoplastic pin is plastically shapeable.

12. The method of claim 8, wherein the bond-inhibiting material is applied after the thermoplastic pin is inserted.

13. The method of claim 8, comprising, prior to inserting the pin through the opening, integrally forming the thermoplastic pin with the first member as a contiguous plastic body.

14. A moveable, plastic-pin joint, comprising:
a first part having a pin extending therefrom;
a second part defining an opening through which the pin extends, the pin having a distal head that overlays a surface of the second part to retain the second part to the first part; and
a layer of pin bond inhibitor disposed between the head of the pin and the second part and inhibiting bonding of the head to the second part.

15. The moveable, plastic-pin joint according to claim 14, wherein the head of the pin comprises a thermoplastic material.

16. The moveable, plastic-pin joint according to claim 15, wherein the layer of pin bond inhibitor is heat resistant to a temperature at which the head of the pin is plastically shapeable.

17. The moveable, plastic-pin joint according to claim 14, wherein the layer of pin bond inhibitor is a film.

18. The moveable, plastic-pin joint according to claim 14, wherein the layer of pin bond inhibitor comprises oil or wax.

19. The moveable, plastic-pin joint according to claim 14, wherein the layer of pin bond inhibitor comprises peppermint wax.

20. The moveable, plastic-pin joint according to claim 14, wherein the layer of pin bond inhibitor covers an area adjacent the opening through which the pin extends.

21. The moveable, plastic-pin joint according to claim 20, wherein the layer of pin bond inhibitor is disposed adjacent substantially all of a side of the head adjacent the second part.

22. The moveable, plastic-pin joint according to claim 14, wherein the first part has at least one degree of freedom of movement relative to the second part.

23. The moveable, plastic-pin joint according to claim 14, wherein the first part is pivotable relative to the second part.

24. The moveable, plastic-pin joint according to claim 14, wherein the first part is slideable relative to the second part.

25. The moveable, plastic-pin joint according to claim 14, wherein the opening is a substantially round hole or a slot.

26. The moveable, plastic-pin joint according to claim 14, wherein;
the first part comprises a first thermoplastic material;
the second part comprises a second thermoplastic material; and
the layer of pin bond inhibitor comprises a material selected to prevent the first thermoplastic material from adhering to the second thermoplastic material when the first thermoplastic material is thermoplastically deformed.

27. A toothbrush, comprising:
a handle and a brush head;
one of the handle and brush head defining an opening, the other of the handle and brush head comprising a pin extending into or through the opening, the pin having a shaft and a headed end that is wider than the shaft and the opening, such that the headed end retains the brush head to the handle; and
a heat-resistant sliding layer disposed between the headed end and an underlying surface adjacent the opening, wherein the heat-resistant sliding layer prevents bonding to the head at a temperature at which the head is plastically deformable.

28. The toothbrush of claim 27, wherein the heat-resistant sliding layer comprises wax.

29. The toothbrush of claim 27, wherein the heat-resistant sliding layer comprises oil.

30. A preform of a moveable, plastic-pin joint, comprising:
a first part having a thermoplastic pin extending therefrom;
a second part defining an opening into which the pin extends; and
pin bond inhibitor disposed on the second part near the opening.

31. The preform of claim 30, wherein the pin bond inhibitor comprises a film of wax.

32. The preform of claim 30, wherein a distal end of the thermoplastic pin extends beyond the opening.

33. the preform of claim 30, comprising:
a hot-gas nozzle pointed toward the thermoplastic pin to heat the pin; and
a ram disposed near the pin to deform the pin.

34. The preform of claim 30, wherein a distal end of the thermoplastic pin is at a temperature at which thermoplastic deformation occurs.

35. The preform of claim 34, wherein, the distal end of the pin forms a head that retains the first part to the second pan, the pin bond inhibitor is disposed between the head and the second part, and the head is not bonded to the second part.
